(19) United States
(12) Patent Application Publication
(10) Pub. No.: US 2017/0161375 A1
(43) Pub. Date: Jun. 8, 2017

(54) CLUSTERING DOCUMENTS BASED ON TEXTUAL CONTENT

(71) Applicant: ADLIB PUBLISHING SYSTEMS INC., Burlington (CA)

(72) Inventors: Cristian STOICA, Oakville (CA); Jean Morel OUELLETTE, Burlington (CA)

(73) Assignee: ADLIB PUBLISHING SYSTEMS INC., Burlington (CA)

(21) Appl. No.: 15/370,512

(22) Filed: Dec. 6, 2016

Related U.S. Application Data
(60) Provisional application No. 62/263,774, filed on Dec. 7, 2015.

(51) Int. Cl. G06F 17/30

(52) U.S. Cl. CPC G06F 17/30707

(57) ABSTRACT

A computer-implemented method and system for clustering electronic documents generates a signature for each document in the form of a sequence of hashes, and saves each signature in a collection of fields of a data store, each hash in a separate field. A search and indexing engine is configured to create an index of all stored signature hashes and to return a document similarity rating in response to a fielded signature query listing hash, field pairs defining a reference signature. Documents which signatures are returned to the query with a similarity rating exceeding a threshold are assigned to a same cluster.

### CROSS-REFERENCE TO RELATED APPLICATIONS

The present invention claims priority from U.S. Patent Application No. 62/263,774 filed Dec. 7, 2015, which is incorporated herein by reference for all purposes.

### TECHNICAL FIELD

The present invention generally relates to computer-based systems and methods of document management, and more particularly relates to systems and methods for content-based clustering of electronic documents stored in computer memory.

### BACKGROUND

Unstructured data that is stored electronically and includes text, such as for example MS Word documents or documents created with any other word processor software, Email messages, PDF documents, blogs, etc., hereinafter termed “electronic documents” or simply “documents”, account for about 80% of all business information and is growing at a fast rate. Organizations must govern a significant amount, often millions, of documents to meet regulatory, legal, environmental, and operational requirements as well as mitigate risk. There is a need in a system that can viably and effectively organize and manage a large volume of electronic documents, and are able to a) identify duplicate and near-duplicate documents, such as for example documents that have minor difference between them, including documents of different file types, and b) accurately cluster documents based on their textual content. Such a system should be able, for example, to compare a new electronic document being added to a collection against millions of other electronic documents in a timely manner, e.g. a few seconds, while minimizing computing resources. Existing document processing solutions have difficulties achieve these tasks in a timely manner.

Accordingly, there is a need for a method of managing large collections of computer-stored documents, which enables fast and efficient clustering of the computer-stored electronic documents based on a similarity of textual content.

### SUMMARY

Accordingly, the present disclosure in one aspect thereof relates to computer-implemented method and system for clustering electronic documents, which are saved in computer readable memory, based on similarity of textual content.

One aspect of the present disclosure provides computer-implemented method and system for clustering electronic documents that generate a signature for each document in the form of a sequence of hashes, and save each signature in a collection of fields of a data store, each hash in a separate field. A search and indexing engine is configured to create an index of all stored signature hashes and to return a similarity rating in response to a fielded signature query listing hash, field pairs defining a reference signature. Documents which signatures are returned to the query with a similarity rating exceeding a threshold are assigned to a same cluster.

In one implementation, the method comprises: for each of a plurality of electronic documents, generating, by a computer, a signature for the electronic document based on a document textual content flow, the signature comprising a sequence of hashes, and storing the signature in a database that is configured for storing data using a plurality of fields, and which comprises a search and indexing engine configured to perform fielded search on data stored in the database. The method may further comprise: for a first document from the plurality of electronic documents, using the search and indexing engine to identify a first set of signatures stored in the database wherein each signature in the first set shares at least a predetermined number of hashes with the signature of the first document; and assigning one or more of the electronic documents which signatures are in the first set to a first document cluster that is associated with the first document.

The method may further comprise storing each hash from the sequence of hashes in a separate field of the database, so that the signature of each electronic document from the plurality of electronic documents is stored in a sequence of fields containing the respective sequence of hashes, and querying the search and indexing engine for stored document signatures comprising at least a predetermined number of fields which content matches corresponding hashes in the sequence of hashes of the signature of the first document. The search and indexing engine may be configured to perform fielded search and indexing of text stored in the database. The search and indexing engine may be configured to perform relevance scoring of the stored text based on frequency statistics of queried terms.

The search and indexing engine may comprise one or more statistics function configured to generate statistics for terms stored in the database and to return a document relevance score based on the statistics in response to a search query. The method may comprise adapting the one or more statistics functions to compute similarity rating for the stored signatures, said similarity rating indicating the number of fields in a stored signature that match fields listed in the query, and to return said similarity rating as the document relevance score.

An aspect of the present disclosure provides a computer system for clustering electronic documents based on similarity of textual content, the computer system comprising one or more memory devices implementing a data store that is configured for storing data using a plurality of fields. The computer system further comprises one or more hardware processors for implementing a search and indexing engine that is configured to perform fielded search and indexing on data saved in the data store, and a document processing logic. The document processing logic is configured to: a) receive a plurality of electronic documents; and b) for each of the plurality of received electronic documents, generate a signature based on a document textual content flow, the signature comprising a sequence of hashes, and store the signature in a sequence of fields of the data store, one hash per field, so that an order of hashes in the sequence of hashes uniquely corresponds to an order of fields in the sequence of fields storing the signature.

The one or more hardware processors may further implement a clustering logic that is configured to perform the following operations: a) query the search and indexing engine with a signature query to identify, among all signatures stored in the data store, a first set of signatures wherein each signature comprises at least a predetermined number of fields which content matches corresponding hashes of a document signature specified in the signature query; and b) assign to a first cluster one or more of the electronic documents which signatures are in the first set.

An aspect of the present disclosure provides a non-transitory computer-readable medium storing a processor-executable code for clustering electronic documents based on similarity of textual content. The code comprises a set of instructions which, when executed by one or more processors, cause the one or more processors to perform operations comprising:

a) for each of a plurality of received electronic documents, generate a signature for the document based on the document textual content flow, the signature comprising a sequence of hashes, and store the signature in a database that is configured for storing data using a plurality of fields, the database comprising a search and indexing engine configured to perform fielded search on text data stored in the database;

b) query the search and indexing engine with a signature query to identify, among all signatures stored in the data store, a first set of signatures wherein each signature comprises at least a predetermined number of fields which content matches corresponding hashes of a document signature specified in the signature query; and

c) assign to a first cluster one or more of the electronic documents which signatures are in the first set.

An aspect of the present disclosure provides a computer-implemented method of clustering documents based on similarity of textual content, the method comprising:

a) generating, by a document processing logic of a computer, document signatures for a plurality of documents based on document textual content flow, each document signature comprising a list of hashes;

b) saving the document signatures in computer memory using a search and indexing engine, so that each hash is stored in a separate field of a data structure containing the signature, the search and indexing engine comprising one or more statistics functions capable of generating an index comprising frequency statistics, and a document scoring function configured to return a document score in response to a search query using the frequency statistics stored in the index;

c) querying the search and indexing engine with a fielded query, said fielded query comprising a list of hashes of a signature of one of the plurality of documents, to identify a set of stored signatures that include one or more fields containing hashes that match corresponding hashes listed in the fielded query, and to compute the document similarity rating for each signature in the identified set, each similarity rating indicating the number of fields of a stored signature which content matches corresponding hashes listed in the query; and

d) assigning documents with signatures in the identified set and the similarity rating greater than a threshold value to a same document cluster.

### BRIEF DESCRIPTION OF THE DRAWINGS

Embodiments disclosed herein will be described in greater detail with reference to the accompanying drawings which represent preferred embodiments thereof, in which like elements are indicated with like reference numerals, and wherein:

FIG. 1 is a schematic block diagram of a document clustering system in an example network environment;

FIG. 2 is a flowchart illustrating general steps of an embodiment of a method of document clustering based on similarity of their text using a fielded database;

FIG. 3 is a schematic representation of a document signature formed of a sequence of signature elements;

FIG. 4 is a schematic block diagram of a database storing document signatures in a plurality of fields;

FIG. 5 is a flowchart of one embodiment of a document clustering process illustrating example steps involved in generating a document signature;

FIG. 6 is a flowchart of an example embodiment of a process of assigning documents to clusters based on document similarity ratings obtained from a database storing document signatures;

FIG. 7 is a flowchart of an example embodiment of a process of assigning electronic documents to clusters of duplicate or nearly-duplicate documents;

FIG. 8 is a high-level block diagram of a computer system that may be used for textual content-based document clustering;

FIG. 9 is a schematic functional block diagram of a clustering information store;

FIG. 10 is a schematic functional block diagram of computer-readable persistent memory and example modules stored therein.

### DETAILED DESCRIPTION

In the following description, for purposes of explanation and not limitation, specific details are set forth, such as particular computer-based systems and techniques, in order to provide a thorough understanding of the present invention. However, it will be apparent to one skilled in the art that the present invention may be practiced in other embodiments that depart from these specific details. In other instances, detailed descriptions of well-known methods, devices, and computer algorithms are omitted so as not to obscure the description of the present invention.

Note that as used herein, the terms “first”, “second” and so forth are not intended to imply sequential ordering, but rather are intended to distinguish one element, step, or process from another unless explicitly stated.

Embodiments described hereinbelow provide a computer-implemented method and system for detecting similarities between individual documents in large computer-based document stores, and for clustering similar documents together in an unsupervised manner. In one embodiment, the method and/or system uses a full-text document-oriented indexed database that is dedicated for storing document signatures and does not contain the documents themselves or any parts thereof.

Advantageously, computer code implementing the method can run in a small operating memory footprint, such as 4 GB or less by way of example, with low CPU resources. In one embodiment, the method derives document similarity ratings relative to a signature of a cluster or to another document. In one embodiment, the method produces document-to-document similarity rating, which may be conveniently used to identify duplicate and/or near-duplicate documents. In one embodiment, the method allows continuous ingestion of documents. In one embodiment, the method provides a coupling coefficient between clusters for further cluster collapsing, i.e. merging two or more clusters, which may be facilitated using document similarity rating and/or clustering history. In one embodiment, the method identifies documents that are duplicates. In one embodiment, the method identifies documents that are near-duplicates.

The following definitions are applicable to embodiments disclosed herein:

The terms ‘computer-stored document’ and ‘electronic document’ are used herein interchangeably to refer to documents encoded and/or stored in a computer-readable format, such as but not exclusively in a text format using ASCII codes and a PDF format. Electronic documents may also be referred to herein simply as documents. The term “full-text search engine” may be used herein in the context of retrieval of a computer-stored text data, and refers to computer-implemented techniques for searching a single electronic document or a collection of electronic documents in a document database. A full-text search engine is a software program that, when executed by a computer, is capable of searching for any term in an electronic document or a collection of electronic documents, and is distinguished from search engines that perform searches based on metadata or on parts of the texts that may be represented or stored in a document database, such as titles, abstracts, selected sections, or bibliographical references. A full-text search engine may typically include an indexing capability and may be referred to as a full-text search and indexing engine. Indexing may include identifying various terms used in a plurality of text documents being indexed, and for each of the terms collating information about documents and/or document locations where instances of a respective term can be found. Examples of full-text search and indexing engines include the Apache Lucene™ search engine, DtSearch® with Spider products, and Elasticsearch™ engine.

A database is a computer program, and an associated computer-readable storage, implementing a data structure designed for storing and retrieving data. Document database is a computer program, and an associated computer-readable storage, implementing a data structure designed for storing, retrieving, and managing document information, also known as unstructured data.

MinHash, or the min-wise independent permutations locality sensitive hashing scheme, is a known in the art technique for quickly estimating how similar two sets are based on a Jaccard similarity coefficient.

The Jaccard similarity coefficient is a commonly used indicator of the similarity between two sets. For sets A and B it is defined as the ratio of the number of elements of their intersection and the number of elements of their union:

$$J ( A , B ) = \frac{\vert A ⋂ B \vert}{\vert A ⋃ B \vert}$$

Shingling is a process of extracting text tokens that can be used to measure the similarity of two documents. Shingles are contiguous subsequences of tokens of a predefined distance. Tokens can be made up of characters, words, etc. The term ‘distance’ when used with reference to shingling, may refer to a number of tokens in a shingle. Text of any document may be presented as a sequence of tokens. Once a shingle distance is defined, the process of shingling document text produces a sequence or list of all possible shingles of a given distance that may be obtained from the text, in the order as they appear in the text.

Near-duplicate documents are documents that mostly contain the same content but are not identical. By way of example, one document containing only the wording “today is a nice day” and a second document containing only the wording “today is a clear day” could be considered near-duplicates.

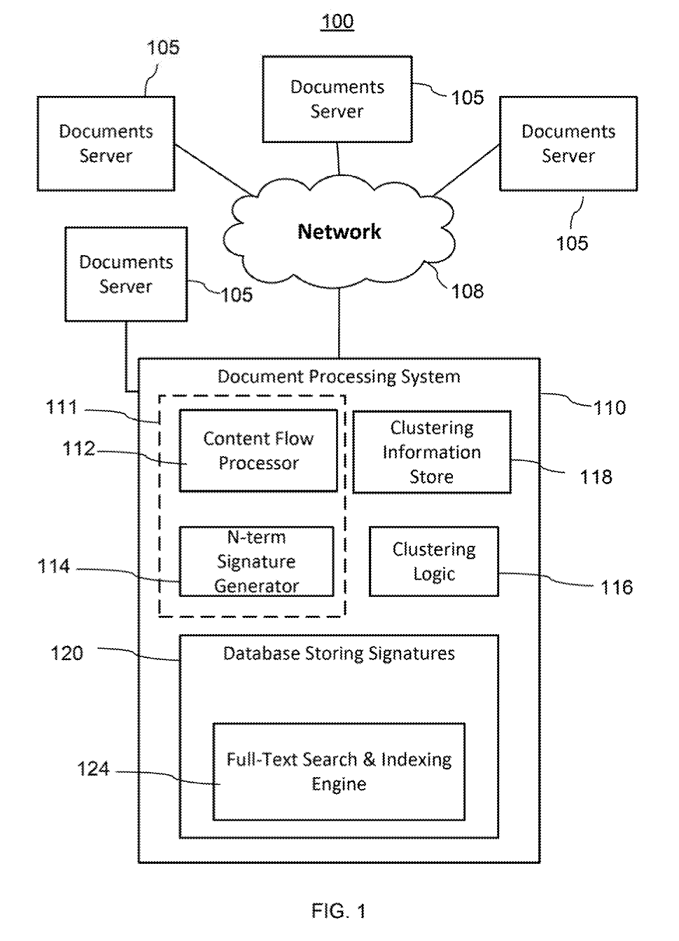

With reference to FIG. 1, there is illustrated an exemplary computer environment 100 in which embodiments of the method for clustering electronic documents described herein may be practiced. In the illustrated environment, a document processing system (DPS) 110 can connects to one or more document servers 105, for example through a network 108, obtain electronic documents therefrom, and cluster them based on similarity of their textual content.

The DPS 110 may be in the form of a computer, or may be implemented in a distributed fashion with two or more computers which in operation communicate with each other and may exchange data. The document servers 105 may be, for example, in the form of computers or network devices, such as for example routers, that are connected to, or include, computer storage devices such as, for example, hard drives, magnetic tapes, optical disks, or solid state drives storing document collections that may be electronically read by the connected computers. The document servers 105 may also be in the form of, or include, any suitable persistent storage device, such as a hard drive, that is directly connected to, or is a part of, a computer or computers implementing the DPS 110. Network 108 may be, for example, the Internet, a local area network, a company intranet, or any suitable computer network that is capable of communicating documents between connected computers.

The electronic documents may be in different formats, for example in the form of text files, MS WORD files, PDF files, scanned documents in any of suitable image formats, and the like. In some embodiments, all of the document servers 105 may be in the form of persistent electronic storage devices, such as a hard drive, that are connected directly to a computer or computers implementing the DPS 110 or a portion thereof. Accordingly, the network 108 may be absent.

The DPS 110 can receive documents from document servers 105 and is configured to processes the received documents and assigned them to various document clusters based on similarity of their content. In some implementations, the DPS 110 may crawl for documents at the document servers 105 using, for example, any of known crawlers. The DPS 110 may process the received documents using a document processing logic or module 111, and then cluster or group the processed documents using a clustering logic 116; storing clustering related information in a clustering information store 118, termed cluster database.

The document processing operations may include the operation of determining the content flow of a document and an operation of determining a document signature; accordingly, the document processing logic 111 may include a content flow processing logic or module 112 and a document signature generating logic or module 114. The DPS 110 may also perform any number of other operations. In some implementations, the DPS 110 can store copies of documents received from document servers 105 in a document depository (not shown). The document signatures generated by the document signature generating logic 114 may be saved in a signature database 120, which may also be referred to herein simply as database 120. In one embodiment, the database 120 is a non-relational indexed database. In one embodiment, the database 120 includes, or is coupled to, a search and indexing engine (S&IE) 124 that is configured to perform a fielded search of data stored in the database 120. In one embodiment, the signature database 120 is implemented using a document-oriented database that is configured for storing text documents using a plurality of fields. In one embodiment, the S&IE 124 is a full-text search and indexing engine. In one embodiment, the S&IE 124 includes one or more term frequency statistics functions and is configured to provide term-based document relevance score in response to a term query. In the context of this specification, ‘term query’ refers to a database search query requesting data related to a frequency of appearance of a requested term in the database. In the context of the database 120, the word ‘term’ may refer to a content of a database field, or a portion thereof, in conjunction with a field identifier. A term query may also be referred to herein as field query. In one embodiment, a term query returns the frequency of appearance of the queried term in the database and information identifying documents wherein the term is found, such as a document ID (DocID). In one embodiment, the S&IE 124 is adapted to provide the document relevance score in the form of a similarity rating that indicate the number of matches between a stored signature and terms listed in a fielded query. In one embodiment, the S&IE 124 may generate an index of the database containing information related to the frequency of appearance of each term stored in the database. By way of example, the database 120 may be implemented using one or several existing suitable commercial or open-source document databases or document search engines, such as for example using Apache Lucene™ information retrieval software library that includes full-text search and indexing capability.

The term “module” as used herein refers to computational logic for providing the specified functionality. A module can be implemented in hardware, firmware, and/or software. Where the modules described herein are implemented as software, the module can be implemented as a standalone program, but can also be implemented through other means, for example as part of a larger program, as a plurality of separate programs, or as one or more statically or dynamically linked libraries. It will be understood that the named modules described herein represent one embodiment of the present invention, and other embodiments may include other modules. In addition, other embodiments may lack modules described herein and/or distribute the described functionality among the modules in a different manner. Additionally, the functionalities attributed to more than one module can be incorporated into a single module. In an embodiment where the modules are implemented by software, they are stored on a computer readable storage device, such as for example but not exclusively a hard disk, loaded into computer memory, and executed by one or more processors included as part of the document processing system 110. Alternatively, hardware or software modules may be stored elsewhere within the document processing system 110. The document processing system 110 includes hardware elements necessary for the operations described here, including one or more processors, operating memory, hard disk storage and backup, network interfaces and protocols, input devices for data entry, and output devices for display, printing, or other presentations of data.

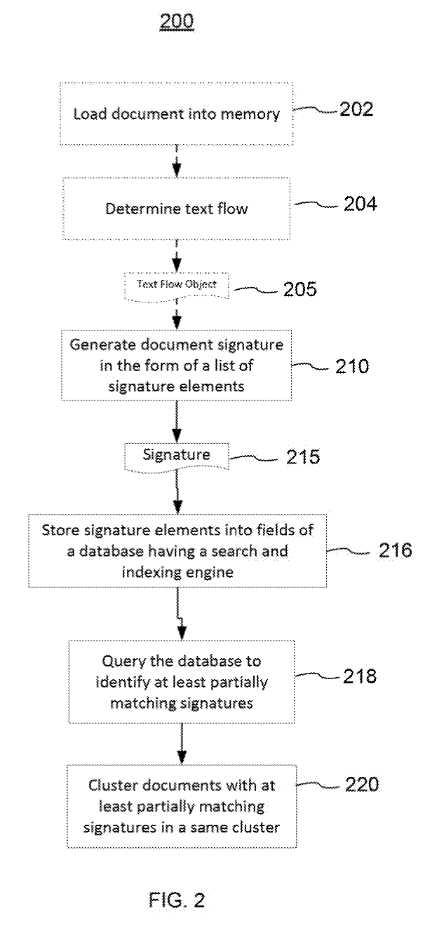

With reference to FIG. 2, the DPS 110 may implement a document clustering process 200 that includes at least some of the following steps or operations. At step 210, the document processing logic 111 generates a signature 215 for a document based on a textual content flow of the document. At step or operation 216, the signature 215 is stored in the database 120. These steps may be repeated for each of a plurality of documents that DPS 110 receives from the document servers 105, so as to populate the database 120 with a plurality of signatures 215. Step 210 may be preceded by step or operation 202 of loading each of the received document into a computer-readable memory of a computer or computers implementing the DPS 110, and step or operation 204 of determining the document's textual content flow, i.e. determining the intended order of various text units that may be present in the document, as described in further detail hereinbelow. The step or operation 204 may generate a text flow object 205, which may be for example in the form of a list or sequence of text tokens, such as a list or sequence of characters, stringed together in an order corresponding to the document text as it is intended to be read. In one embodiment, the text flow object 205 may be then converted into a collection of text data units that may be compared between various documents.

Once the database 120 is populated with a plurality of document signatures 215, the clustering logic 116 may perform clustering operations on the signatures stored in the database 120. The process of grouping documents, or their corresponding signatures, in clusters according to their similarity may be referred to as clustering. Since the signatures 215 have a one-to-one association with the documents, the clustering of the signatures may be viewed as substantially equivalent to clustering of the corresponding documents. Information about document clusters may be saved in the clustering information store 118, or cluster database; such information may contain, for example, a multi-level list wherein a list of clusters contains a plurality of document lists, each document list containing a cluster identifier and a list of all documents belonging to the respective cluster.

Clustering operations may include querying step 218 wherein the database 120 and/or the S&IE 124 is queried for all signatures that at least partially match a signature of a selected document, and a cluster assignment step 220 wherein documents with at least partially matching signature are assigned to a same cluster. Steps 218, 220 may be repeated by querying the database 120 for matches to signatures of a sequence of selected documents which signatures are stored in the database, until no non-clustered signatures remains in the databases, or all the document signatures are tried in a query step 218. In such a process, each cluster may be viewed as associated with the document which signature was used in the query step 218 to identify documents with the at least partially matching signatures. In one embodiment, the DPS 110 carries out the process 200 in unsupervised or automatic manner.

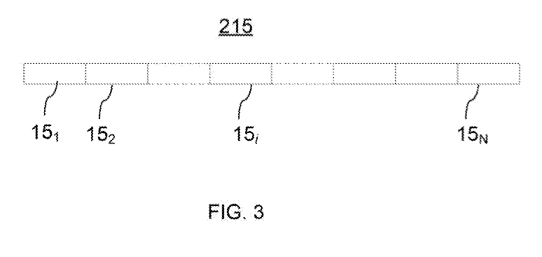

With reference to FIG. 3, in one embodiment the signature 215 may be generated in the form of an ordered sequence or list of signature elements 15₁, 15₂, . . . , 15_{N}, which may be generally referred to as signature elements 15; here N>1 is the number of elements in the signature. Each signature element 15 is then stored as a term in a separate field of the database 120. Each signature element 15 may be, for example, in the form of a sequence of characters or in the form of an integer number, and may be of a same pre-defined length or of different lengths.

Referring back to FIG. 2, the clustering logic 116 may query the S&IE 124 of the database 120 in query step or operation 218 to identify a first set of stored signatures that share at least a predetermined number K of signature elements, or terms, with the signature of a first document. In one embodiment K=1, and the S&IE 124 returns identifiers of those of the stored signatures that share at least one signature element with the signature of the first document. At step 220, documents with signatures in the first set may then be assigned to the first cluster that is associated with the first document which signature was used in query step 218. The signature of the first document, or generally the signature that was used in a query step 218 to identify similar documents, may be referred to as the cluster signature.

In one embodiment the signature elements 15 may differ from any of the terms in the document itself, and may be generated using one or more hash functions; in such embodiments, the signature elements 15 may also be referred to as signature hashes, or simply as hashes or hash numbers.

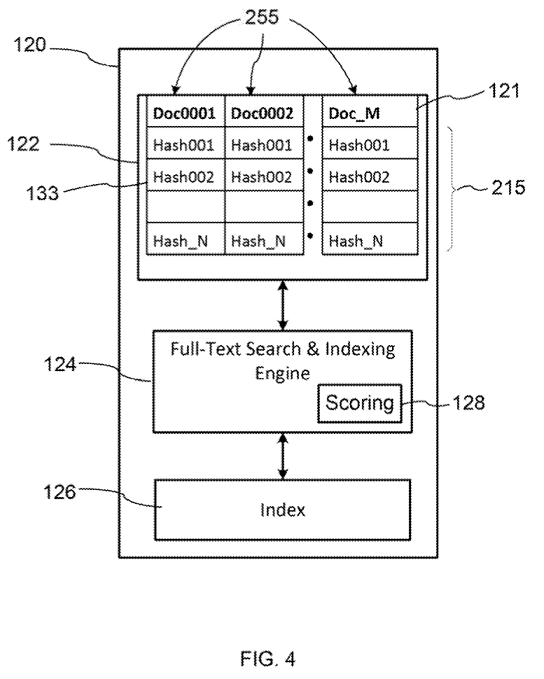

With reference to FIG. 4, in one embodiment the database 120 may include a data store 122 wherein the document signatures 215 are stored, the S&IE 124 that can access the data store 122 to read the signatures and their constituent terms, and an index 126 which stores information about the locations and frequency of stored terms in the data store 122. The data store 122 may also be referred to herein as the signature store 122 and may be dedicated to storing document signatures.

In the illustrated in FIG. 4 example, each signature element 15 is a hash number, so that each signature 215 is in the form of an ordered sequence or list of N hash values {Hash₁, Hash₂, Hash₃, . . . Hash_{N}}, where Hashᵢ, i=1, . . . , N represent the hashes of i^{th} order in the hash sequence, which generally differ from signature to signature. The number N of signature elements or hashes in a signature may be a design parameter, and may vary from tens to hundreds depending on the implementation. It will be appreciated that increasing N reduces the likelihood of collisions, i.e. false positives in identifying similar documents, and raises the likelihood that each signature uniquely represents its document, but also increases the computer storage and processing requirements. By way of example, N=400.

In one embodiment, each hash value of the sequence of N hash values is saved in a separate field 133 of the data store 122. Note that in the illustrated example Hash001, Hash002, Hash003, . . . Hash_N denote the names of the database fields 133 wherein respective signature elements or hashes Hash₁, Hash₂, Hash₃, . . . Hash_{N} are stored. In one embodiment, the data store 122 may be saved in computer-readable memory in the form of a data structure wherein N named fields are created for each stored document signature, and said fields are populated with the respective signature elements or hashes. In one embodiment, that data structure may be represented as a table, where rows represent document signatures and columns represent fields, or vice versa, with each cell of the table populated by a respective signature element, such as a hash. By way of example, Table 1 illustrates a stored document signature 215, with the first column showing a sequence of database field names “Hash001” to “Hash006” and the second column showing unsigned integer hash values of the document signature that are stored in respective fields. Although only six fields and six hash values are shown, it will be appreciated that in a typical embodiment the number N of the stored hashes for each signature, and the number of database fields allocated thereto, may be significantly greater, for example several hundred. Further by way of example, the data store 122 may be a document store defined by a Apache Lucene™ search and indexing engine library, and the fields may be Apache Lucene™ defined fields.

TABLE 1

| Field | Value |
|---|---|
| Hash001 | 3819684751 |
| Hash002 | 1427418745 |
| Hash003 | 3075383514 |
| Hash004 | 1805617407 |
| Hash005 | 2092029963 |
| Hash006 | 2996397903 |

Referring again to FIG. 4, in one embodiment each signature 215 is stored in a separate data structure 255 of the signature store 122, each data structure 255 containing an identifier (ID) or name 121 and an ordered sequence or list of N fields 133 wherein the signature elements or hashes 15 are stored, each in a separate field 133. An order of hashes 15 in the sequence of hashes forming a signature 215 may uniquely correspond to an order of fields 133 in the sequence of fields of the data structure 255 storing the signature. Fields 133 of a same level in different signature data structures 255 may be referred to as corresponding fields of the data store 122, and may have identical names or field IDs. Each data structure 255 storing a signature is assigned a different name or ID 121, such as Doc0001, Doc0002, etc, which identifies the group of fields 133 storing a specific document signature and, therefore, the corresponding document which signature is stored in those fields. The IDs 121 of the data structures 255 may be referred to also as the signature ID or the document ID. It will be appreciated that the notation “Doc0001” etc. is by example only, and the number of leading zeros in the example notations “Doc0001”, “Doc0002”, etc. should be large enough to accommodate an expected maximum number of stored signatures. In one implementation, the signature terms or hashes may be stored in the data store 122 and/or index 126 as pairs (FieldName, HashValue), which may be termed “hash fields”, where “FieldName” is the name or ID of the database field 133, such as “Hash001” by way of example, which may be in the form of a string, and “HashValue” stands for the actual hash value stored in said field, which may be saved for example as a text or string, or an unsigned integer. Two fields 133 of different document data structures 255 are referred to as matching when they match both in field ID and value stored in the field. By way of example, fields “Hash002” of signature data structures 255 named Doc0001 and Doc0002 match if the hash values stored in those fields are identical.

It will be appreciated that each signature data structure 255 may correspond to a specific physical location in a memory device wherein the respective signature is stored, and each field 133 may correspond to a specific physical location in the memory device wherein the respective signature element 15 is stored, with the respective field and signature identifiers pointing to a corresponding memory location.

Although FIG. 4 shows only three signatures stored in the signature store 122, in a typical implementation the signature store 122 may be storing many thousands, or millions or even many billions of document signatures.

Index 126 may be in the form of a data structure, or a collection of data structures, that stores information about the location of different terms stored in the database 120, or, for the exemplary implementation illustrated in FIG. 4, in the signature store 122. In one embodiment, index 126 may be an inverted index that stores, for each signature element or hash 15 kept in the data store 122, identifiers or names of all fields 133 and data structures 255 that contain the term. In one embodiment, each signature term stored in the data store 122 may be defined by a field name and a hash value stored in that field, and the index 126 may store, for each signature term, a list of IDs 121 of document data structures 255 containing the signature term.

The S&IE 124 may implement an indexing function, i.e. the function of generating and/or populating index 126, and may perform this function in an autonomous background regime, so that it automatically updates index 126 following an addition of one or more new signatures to the signature store 122. Performing this function may include identifying all unique terms, i.e. identifiable data units such as hashes 15, stored in the signature store 122, and collecting locations of all instances of these terms in the data store 122. The S&IE 124 may also serve as an interface between the clustering logic 116 and the signature store 122 and/or the index 126. The S&IE 124 may also include one or more statistics or frequency functions that provide information related to the frequency of appearance of a signature term or terms in the data store 122 based on information stored in the index 126. By way of example, such statistics or frequency functions may include a function that provides a list of locations in the data store 122 where a particular value can be found in a specified field 133, such as the IDs 121 of all document or signature data structures 255 that include the value in the specified field, and a function that returns the frequency, or the count, with which a specific location in the data store 122, such as a specific document or signature data structure 255, appears in a response to a query specifying one or more terms, such as one or more (field, value) pairs.

In one embodiment, the S&IE 124 may perform fielded search on data stored in the data store 122. The term “fielded search” is used herein to mean a search for all locations in the database, e.g. all document data structures 255, where specified values can be found at specified fields. By way of example, a fielded search for stored document signatures that share one or more fields with a reference signature, such as the signature of a first document, may be initiated with a query string containing a list of hash fields of the reference signature joined with logical OR operators, each hash field defined by a field name paired with a corresponding hash from the sequence of hashes forming the reference signature.

In one embodiment, the S&IE 124 may include a scoring function or functions 128 that generate a similarity rating in response to a query listing hash fields of a document signature, the similarity rating indicating how similar a stored signature is to the signature defined in the query.

In one embodiment, the S&IE 124 may be implemented using a full-text search and indexing engine that is configured to perform fielded search and indexing operations across all fields in the data store 122, and is further configured to return a document relevance score in response to a query, said relevance score indicating how relevant a particular stored document is to the query. By way of example, the S&IE 124 may be implemented using Apache Lucene™ full text search library, which stores document text data in a collection of fields, and includes a library of search and indexing functions that is capable of performing fielded searches for a specific term or a list of terms in response to a term query, and can return IDs of all stored documents. It also includes a scoring function that returns a document relevance score in return to a term query. By storing document signatures, instead of electronic documents themselves, in the fielded data structures of Lucene, or other similar document database that is conventionally intended for storing text documents, the full-text search, indexing, and document scoring facilities of a document-oriented search engine such as Lucene may be used to quickly and efficiently determine how similar any stored signature is to a queried signature in terms of a number of matching terms or fields.

Although other types of queryable database may be used for saving the signatures, using a document-oriented full-text search engine such as Apache Lucene enables to leverage their indexing efficiency and speed to respond to long search queries, e.g. with search criteria containing many hash numbers with multiple OR conditions, in a very short time, e.g. in milliseconds, using relatively small amount of operating memory and low CPU resources.

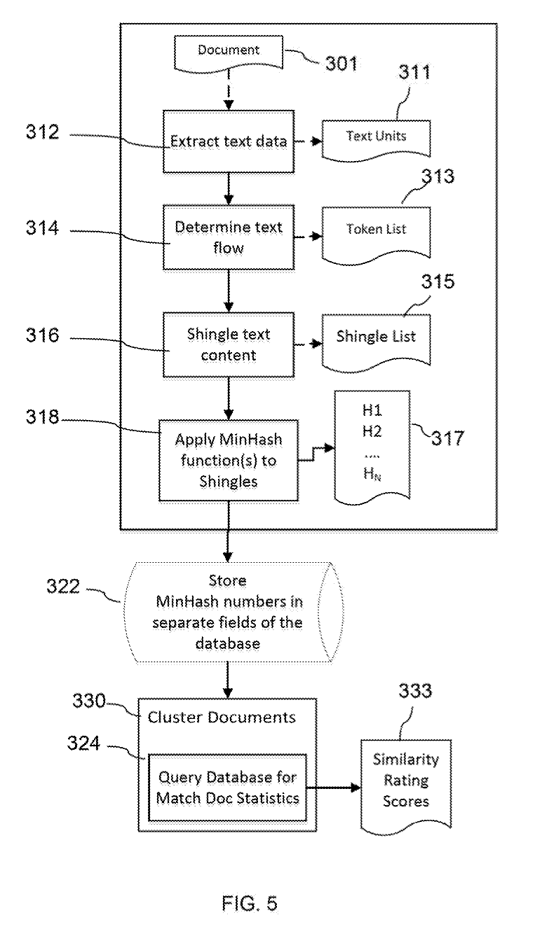

Turning now to FIG. 5, there is illustrated a flowchart illustrating an example embodiment of the method 200 and detailing possible operations that may be involved in generating a signature of an electronic document, here indicated as document 301. The electronic document 301 may be received by the DPS 110 in one of a plurality document formats, both text-based and image-based. If the electronic document 301 was saved and received as an image, it may be first converted into a suitable text-based format, for example using one of known in the art OCR (optical character recognition) methods.

By way of example, the electronic document 301 may be in a PDF format wherein the document is composed of text units or blocks and may also include images.

The process may start with step or operation 312, in which text data are extracted from the document 301. This step may include, for example, loading the document 301 in computer memory, and identifying all text units 311 contained in the document. By way of example, in a PDF file units of text may be defined by their X and Y page position and bounding box.

At step 314, a document textual content flow is determined based on the information contained in the text units 311, and text extracted from all text units 311 is combined together in a reading order. This results in a sequence or list 313 of text tokens, wherein the tokens follow each other in accordance with the logical text flow. The tokens may be for example in the form of individual characters or words. In an example embodiment described hereinbelow, the tokens are characters.

Step 314 may include using one or more sorting algorithms to group tokens that logically belong together, e.g. form a paragraph, and consistently determine the order of these groups for a page so that the order is as similar as possible to how a human would read the page. In one embodiment, this step may represent the document 301 as a document textual content flow object CON(D), where “D” stands for a document identifier. CON(D) may be in the form of, or define, a continuous sequence of tokens 313, e.g. as a sequence of characters, in the reading order. This step may also include identifying structural elements of the document text such as paragraphs, columns, tables, page numbers, headers, and footers. In some embodiments, only a portion of the document text may be converted into the token sequence 313.

In one embodiment, the sequence of characters or tokens representing the textual content flow of the document may be first converted into a collection of text data units which may be referred to as shingles or n-grams. For example, each contiguous sequence of n characters in the document text may be a shingle. In one embodiment, the document text may be converted into a list of shingles, or n-grams, of a selected length or distance n.

By way of example, document 301 may include the following text “today is a nice day”, with different characters defined in the PDF file to be located on a page within different specified boxes defined by their x and y coordinates on the page, and the width and height of the box. For example the PDF file may define one text block or unit containing a sequence of characters “y i” to be located at (x1,y1,width1,height1), another text block or unit containing “day” at (x2,y2,width2,height2), “toda” at (x3,y3,width3,height3) and “s a nice” at (x4,y4,width4,height4). The operation at step 312 may identified all four of these text blocks or units, and extract the text or text tokens containing in them. Step 314 may include an operation that determines, based on the extracted text units and their position on the page, the text flow to be “today is a nice day”, and presents the identified text of the document as the sequence of tokens 313, for example in the form of the content flow object CON(D).

Step 316 applies a shingling operation on the token sequence 313. It converts the sequence of tokens 313, which may be for example in the form of the document content flow object CON(D), in a sequence of shingles 315. For the simplified example case considered hereinabove wherein the document text is “today is a nice day” and is 19 characters long including the space characters, the shingling operation 316 may use each character as a token and perform the shingling with the shingle distance or length n=4, and produce the following sequence of 17 shingles: {(toda), (oday), (day), (ay i), (y is), (is), (is a), (s a), (a n), (a ni), (nic), (nice), (ice), (ce d), (e da), (day)}; here each shingle is represented by n=4 characters within a pair of brackets, and consecutive shingles are separated by a coma.

In some embodiments, only a portion of the document text may be shingled. The sequence or list of shingles 315 is then used to generate the document signature 317 at step 318 in the form of a sequence or list of signature elements H₁, H₂, . . . , H_{N}, which may be generally denoted Hᵢ, where i=1, . . . , N.

In some implementations, the signature elements H, may be hash numbers, or hashes, that are generated using locality sensitive hashing, such as MinHashing. The hashes generated at 318 using a MinHashing technique may also be referred to herein as MinHashes, and the resulting ordered sequence or list of minimum hash numbers represents the MinHash signature of the document. In implementations using MinHahsing, the MinHashes Hᵢ embody the hashes Hashᵢ, i=1, . . . , N describe hereinabove with reference to FIGS. 3 and 4.

MinHahsing may be implemented in a variety of ways. For example in one embodiment a hash function from a family of N hash functions may be applied to each of the shingles in the shingle list 315 to produce a hash number for each of the shingles, and the smallest of the hash numbers is selected as the MinHash for each hash function, with the process repeated for each of the N different hash functions to generate the list 317 of N MinHashes Hᵢ forming the signature of the document 301. In one MinHashing implementation, the greatest of all hash numbers for each hash function may be selected. In another implementation, a different selection rule may be applied to select a hash value and chosen as the Hash for each of the hash functions.

The hash functions may be selected that are fast in execution and have a low collision rate. In some implementations the shingles may first be converted from a string to an integer. For example, a djb2a hash function, known to have a low collision rate and fast computation may be used.

In one example implementation, the family of N hash functions may be in the form of a seeded hash function that depends on two inputs, data d and seed s. The seed s may be a pseudo-randomly generated number, and the data d may be a shingle, which length in bytes is defined in part by the used shingle distance n. Each of the N hash functions may be provided by a same two-input hash function of the form H(S,D) that returns a real number for each pair of (S, D) values, and the full set of N hash functions corresponds to N different randomly-generated seed values S. The hash function H(S,D) may be one of conventional hash functions known in the art, such as, but not limited to, a Jenkins hash function, a Bernstein hash function, a Fowler-Noll-Vo hash function, a MurmurHash hash function, a Pearson hashing function, or a Zobrist hash function.

In another implementation only one hash function may be used, and the sequence of N signature hashs Hᵢ in step 318 may be obtained for example by selecting N smallest hash values or N largest hash values from a plurality of all hash values generated by applying the hash function to the sequence of shingles 315.

It will be appreciated that the textual content flow object 313 for many types of documents may contain thousands of characters, and the list of shingles or n-grams may contain thousands of shingles. The selection of a token, the value of the distance n, and the number N of hashes in the signature may vary depending on an implementation. By way of example, n=12, N=400, and the token is character.

An ordered set or list of the N MinHash numbers may form the signature 317 of the document, which is stored in the database 120 at step or operation 322, for example as described hereinabove with reference to FIG. 5. Steps or operations 312-322 may be repeated for a plurality of received documents, so as to populate the database 120 with a plurality of signatures. In a document clustering process 330, the database 120 holding the signatures may be repeatedly queried, at a query step 324, for statistics of matching MinHash numbers between stored signatures of different documents, and the results of the queries used to cluster the documents to different clusters based on similarities of their signatures.

It will be appreciated that other ways to generate the sequence of signature elements 317 based on the token sequence 313 may be envisioned without departing from the scope of the present disclosure. Embodiments may also be contemplated wherein the signature elements H; are generated in other ways, for example without shingling the tokens of the document text flow, or using token elements other than character.

Once the signatures of a plurality of documents are saved in the document database 120, in step 322 they may be assigned to different clusters based on their similarity, as may be determined by suitably querying the document database 120 for the saved signatures to create clusters, such as for example described hereinabove with reference to FIG. 2.

In one embodiment, the clustering process 330 may include comparing the stored signatures to a reference signature, i.e. a signature of a reference document, computing a similarity rating 333 for each of the compared signatures, and repeating the process for a plurality of reference signatures stored in the database. At each iteration, a signature of a newly received document or one of the stored signatures may be selected as the reference signature and used in a query to compare to other stored signatures to identify those that are similar to the current reference signature.

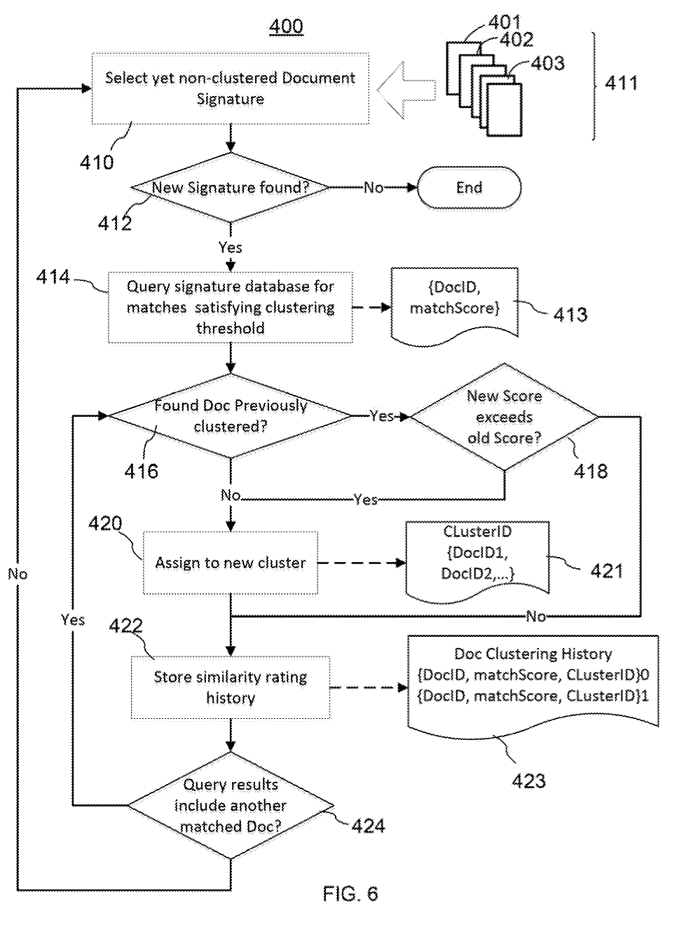

Turning to FIG. 6, there is illustrated a flowchart of an example embodiment 400 of a clustering process 330 wherein documents 411 are assigned to clusters based on similarities of their signatures stored in the signature store 122 of the database 120. The process 400, which may be autonomously executed by the clustering logic 116 of the DPS 110 of FIG. 1, may start at step 410 with selecting a first document 401, which in this example may be labeled “Doc1”, as a reference document, and proceed to query, at step 414, the S&IE 124 of the database 120 for stored signatures that have one or more fields that match a signature of the first ‘reference’ document 401 Doc1. The query, which may be referred to as the signature query, may lists the signature hashes Hᵢ of Doc1 field by field. The ‘reference’ signature, which hashes may be listed in the query paired with corresponding field IDs, may be referred to as the queried signature or the query signature. In one embodiment, the query at 414 may return identifiers (DocIDs) of all stored signatures that have at least one field that matches the corresponding field of the queried signature. In one embodiment, the query may return DocIDs of all stored signatures that have more than a specific number of fields that match the corresponding field of the queried signature. If no signatures with a desired number of matching fields is found, a new reference document may be selected from those which signatures are stored in the database 120, and the database then queried with this new signature.

In one embodiment, the query at 414 may also return for each found document a similarity rating 333, denoted in FIG. 6 as “matchScore”, which indicates the number of matched fields for each identified document signature. Step 414 may also include comparing whether the returned similarity rating 333 “matchScore” satisfies a clustering threshold, which may be pre-defined.

In executing this query, the S&IE 124 of the database 120 may read information stored in the index 126, which may already contain relevant statistics listing document IDs for each stored hash field, thereby significantly reducing the query response time.

As a result of a first execution of step 414, a first set or list of signatures 413 that share at least a predetermined number of signature terms, or hash fields, with a signature of the first ‘reference’ document may be identified. If none of the documents which signatures are stored in the database 120 have been clustered yet, a sub-set of documents 411 which signatures are in the first set 413 may then be assigned at step 420 to a new cluster 421. The assignment may then be recorded in the cluster database 118 indicated in FIG. 1, for example in the form of a data structure containing a cluster identifier (clusterID) and a list of document identifiers. The first cluster 421 created in this way is associated with the first document “Doc1” 401 which signature was used in the query; accordingly the signature of the first document 401 may be viewed as the cluster signature of the newly created cluster.

In one embodiment, the clustering information stored in the cluster database 118 may also include clustering history information for the documents. The clustering history information may be for example in the form of a suitable clustering history data structure 423, which may be defined for each document which signature has been returned by the S&IE 124 in response to a signature query. In one embodiment such clustering history data structure 423 may list a document ID and a similarity rating (SR) ‘matchScore’ for each cluster to which the document has been historically assigned, together with the corresponding cluster ID.

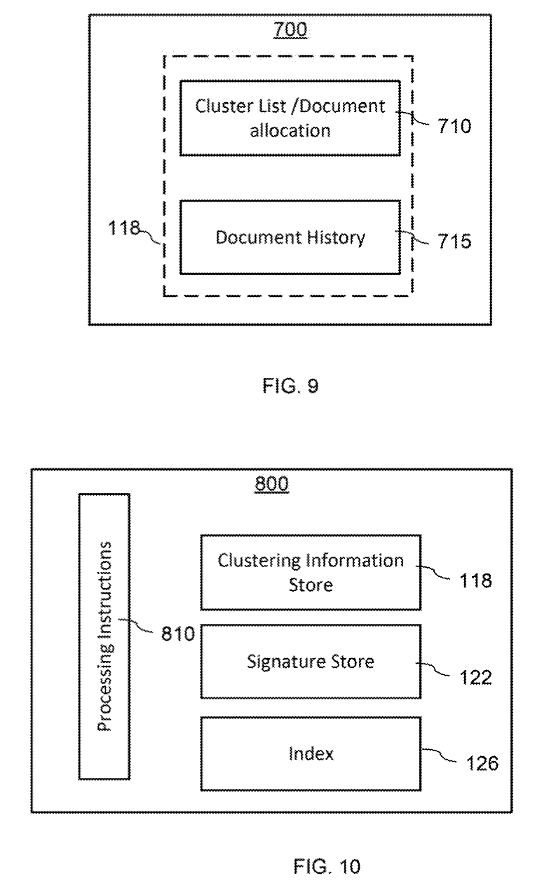

With referenced to FIG. 9, the cluster database 118 may be saved in a persistent memory in any of a plurality of suitable forms, for example simply in the form of a file or files listing all clustered documents for each of the clusters. FIG. 9 illustrates an example persistent memory device 700 storing the clustering database 118. In the illustrated example, a first memory portion 710 stores a list of clusters 421 identifying documents allocated to each cluster, and a second memory portion 715 storing the document clustering history information, which may be in the form of document clustering history data structure 423.

By way of example, the number of hashes in a signature N=400, and the fields 133 for each stored signature have indices or names “Hash001” to “hash400”, the query at 414 for all stored signatures that share one or more hash fields with a reference signature, may include a listing of all signature terms of the reference signature joined with OR operators, wherein each signature term is in the form of a field name followed by the signature hash value stored in the field. For example in an embodiment wherein the signature database 120 is implemented using an Apache Lucene™ full-text search and indexing library, the first two hash numbers of the signature of the first ‘reference’ document Doc1 are 3819684751 and 1427418745, and the last hash number is 3258347801, the query at 414 of the process of FIG. 6 may include the following string of 400 terms joined by “OR”: {Hash001:3819684751 OR Hash002:1427418745 . . . . OR Hash400:3258347801}. Such query may return a list of all signatures which have at least one matching field with the queried signature of Doc1. In the absence of the term location information stored in the database index 126, this query would require comparing stored signatures to the queried signature of Doc1 field by field. For example it may include comparing the content of field “Hash001” of Doc1 to that of “Hash001” of Doc2, the content of field “Hash002” of Doc1 to that of “Hash002” of Doc2, etc. In the presence of the inverted database index 126, the S&IE 124 may obtain information requested by the query directly from the inverted index 126, which lists all signature terms against document signatures containing said term as a result of prior indexing of the data store 122 by the S&IE 124. Furthermore, the query at 414 may also return a similarity rating “matchScore” for each returned signature, which indicates the number of fields in the stored document signature that match the fields listed in the query, and which could be readily computed from the term location information stored in the index 124 with minimal computing resources.

Continuing to refer to FIG. 6, after assigning the first set of documents to the first cluster, the operation may return to step 410 to select a new document signature, for example a signature of a second document 402 from the plurality of stored signatures of documents 411, and repeat the query step 414 with the newly selected signature as a new reference signature. In one embodiment, step 410 may select only from stored signatures of those documents which have not yet been assigned to a cluster, skipping signatures of all previously clustered documents. In response to this 414 query listing hash fields of the second ‘reference’ document signature, the S&IE 124 may return a second set 413 of signatures stored in the database 120 wherein each signature in the second set matches at least a predetermined number of hash fields listed in the query. In one embodiment, the S&IE 124 may return all signatures having at least one matching field, and the clustering logic 116 may then select for the second set those signatures where the number of query matching fields exceeds a threshold defined for a new cluster. At step 420, at least some of the signatures of the second set, and/or the corresponding electronic document or documents, may then be assigned to the new, e.g. second, cluster 421.

In one embodiment, the clustering process 400 may include step 416 to check, for example by accessing information in the clustering database 118, whether any of the document signatures in the second set 413 were previously assigned to a cluster. If one of the identified signatures has been already assigned to a cluster, for example it is determined that a signature of a third document 403 that is returned by the current query at 414 has been assigned to the first cluster with a first similarity rating, which may be denoted matchScore1, in one embodiment the execution may proceed to step 418. Step 418 may compare a second similarity rating for the third document 403, denoted matchScore2, which is obtained for the third document's signature at step 414 in response to the current query denoted, to the first similarity rating matchScore1 stored for the third document 403 in the document clustering history 423. If the new similarity rating for the document, matchScore2, exceeds the previously returned similarity rating, matchScore1, associated with the previously created cluster, the document may be re-assigned to the new cluster at step 420. If the new similarity rating matchScore2 for the third document 403 is smaller than the first similarity rating thereof, matchScore1, associated with the previously created first cluster, the third document 403 may remain assigned to the first cluster. In either case, the document clustering history information for the third document 403 may be updated at step 423 with the new cluster ID and the new similarity rating matchScore2. In one embodiment, the new clustering information is appended to the data structure 423 without deleting the previous clustering information so that the document clustering history is kept in the document clustering history data structure 423.

In one embodiment the document may be assigned to the new cluster without removing it from the cluster to which it has been assigned earlier, so that one document may be assigned to two or more clusters.

The process 400 may continue iterating the sequence of steps 410 to 422 illustrated in FIG. 6 until all the documents 411 with signatures in the document database 120 are assigned to a cluster, or all document signatures stored in the database 120 used in a 414 query.

In one embodiment, the quality of clusters may be further refined using a method of cluster collapsing or merging, wherein clusters of documents with similar textual content may be merged together. The decision whether two clusters are to be merged may depend on a degree of their similarity, which may be measured using a parameter that may be referred to as a cluster coupling coefficient or a collapsing coefficient. In one embodiment, a collapsing coefficient may be defined in relation to the two clusters based on a number of documents in the clusters that have historically be referenced to two clusters, which may be obtained from the document clustering history information 423 which has been stored during the initial clustering process.

In one embodiment, the collapsing coefficient C for two clusters may be computed as the sum of the number of documents that were historically referenced to both clusters, divided by the total number of documents in both Clusters:

$$C = \frac{CountDocsCluster 1 toCluster 2 + CountDocsCluster 2 toCluster 1}{CountDocsCluster 1 + CountDocsCluster 2}$$

Where CountDocsCluster1toCluster2 is the number of documents that are currently assigned to Cluster 1 but pass the threshold of, and/or have been previously assigned to, Cluster 2, and CountDocsCluster2toCluster1 is the number of documents that are currently assigned to Cluster 2 but pass the threshold of, and/or have been previously assigned to, Cluster 1. CountDocsCluster1 is the number of documents in Cluster 1, and CountDocsCluster2 is the number of documents in Cluster 2.

Both the collapsing/merging and the initial clustering may be defined against configurable thresholds. By way of example, two clusters may be collapsed, or merged, into one only when the collapsing coefficient C is above a predetermined threshold, for example 0.5, and a document may be assigned to a cluster only when the matching similarity rating, e.g. the number of MinHashes in its signature that are in common with the document signature being queried, is greater than a threshold number, for example is greater or equal 3.

By way of example, an implementation of the database 120 stores signatures (S1, . . . , S5) of five documents (Doc1, . . . , Doc5). The clustering process 400 may start by querying the database with the signature S1 of Doc1. If S1 matches the stored signature S2 of Doc2 in four fields, i.e. have four signature hashes matching corresponding hashes of the signature S2 of Doc2, and S1 further matches the stored signature S4 of Doc4 in six hashes or fields, the query may return the ID of Doc2 with a similarity rating matchScore1=4, and the ID of Doc4 with a similarity rating matchScore2=6. The clustering process 400 may then form a cluster ‘Cluster1’ containing (Doc1, Doc2, Doc4) where the signature of the cluster may be S1 or a pair Doc1-S1. In one embodiment these three documents Doc1, Doc2, Doc4 may be excluded from being used in further queries—but not from the database search in response to the queries—since they are already clustered. The process 400 continues with querying with respect to a next document signature on the document list that wasn't clustered already, which in this example would be the signature S3 of the document Doc3. The signature query for S3 may return, for example, that the Doc3 signature S3 matches the stored Doc4 signature S4 at 12 fields. Since Doc4 matches Doc3 in a greater number of fields than Doc1, the process 400 may create a second cluster ‘Cluster2’ with S3 or DOC3-S3 being the signature of the new cluster and Doc4 part of that cluster.

In one embodiment, the process may also retain the similarity rating history indicating that Doc4 matched in the past Cluster1 with signature of Doc1-S1. This information may be used later in cluster collapsing. The clustering history 423 may for example contain a list of duplets (ClusterID, matchScore) for each document which ID was returned in response to a signature query 414 during the clustering process. Here “ClusterID” is a cluster identifier, which may be in the form of a string or a number, and “matchScore” is a numeric similarity rating value returned by the respective 414 query, which may be for example in the form of an unsigned integer. At this point, the process has two clusters determined: Cluster1 containing (Doc1, Doc2) and Cluster2 containing (Doc3, Doc4). The process may have also retained, i.e. stored, information about a relationship between Cluster1 and Cluster2, which in this example is defined by Doc4 that at some point of the process belonged to Cluster1 but is a better match for Cluster2.

Next, the process continues by querying the database 120 with a signature of a next yet non-clustered document, which in the current example is the signature S5 of Doc5, which is the only one left to query. It may be found to match only itself, creating a third cluster “Cluster3” containing only Doc5, which may complete the process. In another implementation the process may compute a collapsing coefficients for Cluster1 and Cluster2, since Doc4 belonged to Cluster1 at one step of the process but was then assigned to Cluster2. In this example the cluster coefficient may be computed as C=¼=0.25, as the number of documents historically referenced to both Cluster1 and Cluster2 is 1 (one), i.e. Doc4, and the total number of documents in both clusters is 4. The collapsing coefficient for the pair of clusters Cluster3 (Doc5) and Cluster1 (Doc1, Doc2) is 0 since they don't share any documents historically. If a collapsing threshold is set to 0.5, no clusters are merged, so the total number of clusters remains 3. If the collapsing threshold is set to 0.25 or less, Cluster1 and Cluster2 are merged to form a single cluster containing four documents (Doc1, Doc2, Doc3, Doc4). This new cluster may be assigned a same ID as one of the two merged clusters, or a new ID.

The embodiment of the clustering process described hereinabove searches for a best-fit document selection, where the documents are assigned to clusters to which they have the best affinity, i.e. the greatest number of stored signature terms, for example MinHashes, in common. Looking for the greatest number of shared MinHashes as signature terms conforms to a criterion of similarity given by the Jaccard coefficient, which defines the similarity of two sets as the intersection of sets, which in this example given by the number of matching MinHashes in two document signatures, divided by the union of two sets, which in this example is the total number of MinHashes in the two document signatures.

TABLE 2

| Doc No | SR | DocId | Hash001 | Hash002 | Hash003 | Hash004 | Hash005 | Hash006 |
|---|---|---|---|---|---|---|---|---|
| 1 | 6 | 101441 | 3819684751 | 1427418745 | 3075383514 | 1805617407 | 2092029963 | 2996397903 |
| 2 | 4 | 108209 | 8938656246 | 1427418745 | 7349452092 | 1805617407 | 2092029963 | 2996397903 |
| 3 | 1 | 109762 | 3819684751 | 8741427415 | 7468585920 | 4071805617 | 6322009299 | 9032963997 |
| 4 | 3 | 104887 | 3819684751 | 1427418745 | 3075383514 | 5618010407 | 9006327263 | 8792272051 |

By way of example, Table 2 illustrates a possible response of S&IE 124, implemented using an Apache Lucene full-text search an indexing library, to the signature query listing hashes of a reference signature of a document Doc1 having document ID 101441. The first column in the table is a document number, the second—similarity rating (SR) returned by the S&IE in the form of a number of matching fields N_{match}, the third—document ID 121 as used in the data store 122 of the database 120 illustrated in FIG. 4, and the rest of the columns are signature hashes stored in the database fields associated with each document, with the names or IDs of the fields given in the first row. The bottom four rows correspond to documents returned by the S&IE 124 in response to the query. In this simplified example, each document signature contains N=6 hash numbers that's are stored in 6 fields 133 which names are given in the top row. It will be appreciated that practical implementations may have much greater N. In this example, the query listing hash fields of the Doc1′ signature returns the queried signature of Doc1 with the highest SR of N, which is 6 in this example, as its signature perfectly matches itself at each field, and also returns three more documents with document IDs 108209, 109762, and 104887, which stored signatures have 4, 1, and 3 matching database fields with the signature of Doc1, respectively. For example, the signature of Doc No 2 matches the queried signature of Doc No 1 at fields Hash001, Hash003, Hash004, and Hash005, returning the SR of 4 equal to the number of matched fields, while the signature of Doc No 3 matches the queried signature of Doc No 1 at a single field Hash001, corresponding to the SR of 1. In one embodiment, all four of the return documents may be assigned to a same cluster, as each of them match the queried reference signature of Doc1 at at least one field. Another implementation of the clustering process 400 may use a higher clustering threshold; e.g. in such implementation only documents with more than a certain number or percentage of fields shared with the queried signature may be clustered. For example if the similarity threshold for clustering is 50%, which corresponds to three matched database fields in the signature database, only three of the four documents from Table 2 will be assigned to the cluster, with document Doc No 3 remaining outside of the cluster.

Although existing full-text search and indexing engines typically include various frequency statistics and scoring functions, they do not commonly provide a score function that directly identifies the number of matching fields or terms between two stored documents or a stored document and terms listed in a query. However, their scoring functions can be configured to provide the desired matching field information, such as the number of matching fields N_{match}, so that the desired query response of the type illustrated in Table 2 may be obtained without requiring any additional lengthy computations.

By way of example, a built-in scoring function of the Apache Lucene™ engine may return a document relevance score in response to a term query. The relevance score estimates how relevant a stored electronic document is to the query. Conventional Lucene relevance score does not show the number of matching fields between two documents, and may not be a sufficiently good indicator of a match between the two documents to use in clustering. Accordingly, in one example embodiment that may use the Lucene search engine, its scoring function may be modified to show the number of field-by-field, or hash-by-hash matches between stored documents, in particular when the stored “documents” are document signatures, thereby providing a definite indication of signatures similarity to a reference signature if the hash fields of the reference signature are used in a query as described hereinabove.

Further by way of example, a conventional implementation of Apache Lucene™ engine may use a scoring model, termed Similarity class, that employ seven scoring functions, or methods, which are indicated in the first column of Table 3. These scoring functions are described in detail in the Apache Lucene literature, which is available online. By modifying the Lucene scoring functions or models as indicated in the right column of Table 3, the Lucene scoring may be configured to return the number of fields in a stored document matching the fields listed in the query. i.e. the document similarity rating 133, in place of the conventional Lucene document relevance score.

TABLE 3

| Method | Modification |
|---|---|
| ComputeNorm | No Change |
| LengthNorm | Return 0 |
| QueryNorm | Return 1 |
| Tf | No Change |
| SloppyFreq | Return 0 |
| Idf | Return 1 |
| Coord | No Change |

One advantage of an implementation of document clustering, wherein a search and indexing engine, which is designed for performing full-text searches of text documents, is used to store, index, and search document signatures formed by a list of hashes as “documents” rather than the actual text documents, is the speed and efficiency with which the engine responds to a query for documents with matching fields or terms, as such information is contained in the index created by the engine in an explicit form and does not need to be produced anew for each query. Furthermore, the relevance scoring of conventional full-text search engines can be readily adapted to provide a score directly indicating the number of matches per document. The queries at step 414 run at the speed of the full-text search engine and report the similarity rating value as part of the search result. The full-text index and search engine requires little CPU and operating memory resources in processing the signature queries of the type described hereinabove and can be distributed across different processes and computing resources. The method may operate with a small operating memory footprint since only the document ID and similarity rating values returned by the database in response to the queries need to be held in the operating memory, and not the totality of the stored document signatures. By way of example, in one trial implementation of the DPS 110 using an Apache Lucene™ full-text search engine with the modified scorer to store and process document signatures as described hereinabove, the clustering time for 150,000 documents was reduced by a factor of 50 as compared to processing the signatures directly in computer memory to identify and score those with matching signature terms. Advantageously, the method described hereinabove is highly scalable and may be used to cluster millions of documents.

It will be appreciated that particular features of the clustering process described hereinabove with reference to FIGS. 2, 5 and 6 may vary from implementation to implementation, and the process may be implemented with several variations in a single system. For example in one such variation the clustering process may be similar to the process 400 described above, but without the exclusions of already-clustered documents from being used in the queries at step 414.

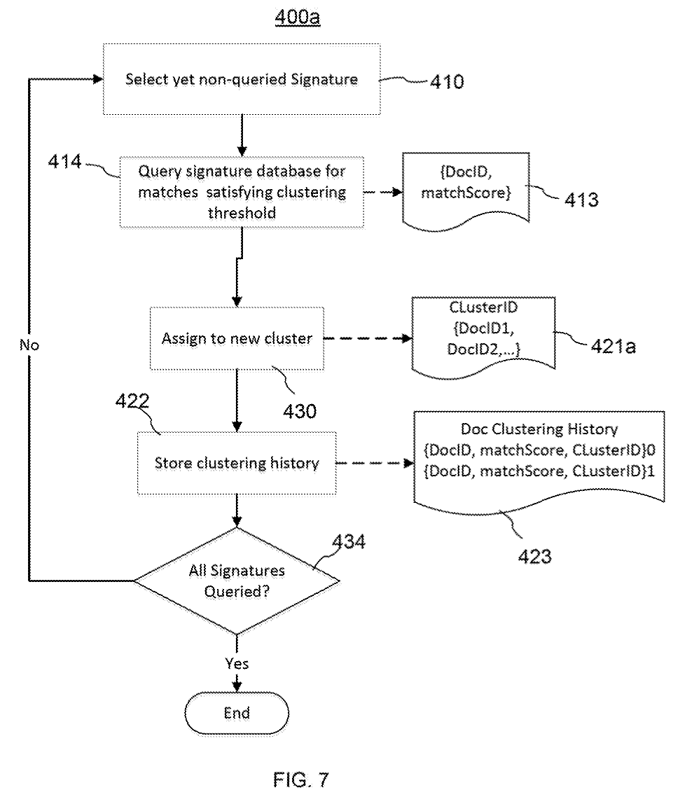

Referring to FIG. 7, the clustering process 400 may have a variation or mode that is generally indicated as process 400a and which may be useful in identifying duplicate and near-duplicate documents. In this mode or variation of the process 400 of FIG. 6 the operations 416, 418, 424 may be omitted. The operation of this version of the clustering process may be illustrated with reference to the above described example wherein a query with the Doc1 signature results in the assignment of Doc1, Doc2, Doc4 to Cluster1; in the variation 400a of the process the signatures of documents Doc2 and Doc4 are not excluded from being queried against in subsequent iterations of the clustering process 400a. Querying the database with signatures of these already clustered documents provides similarity rating for these documents relative to all other documents which signatures are saved in the database 120. Accordingly, this version of the clustering process enables comparing all pairs of nominally different documents (Doc_n, Doc_m) having similarity rating above a configurable threshold. The similarity rating may be expressed as the number of matching database fields, or as a percentage of matching database fields relative to the total number of the database fields N that are used to store each signature.

The resulting scores may be analyzed at step 430 to identify duplicate or near-duplicate documents, such as by comparing the similarity rating for each document to a configurable threshold. By way of example, at step 430 each pair of documents which similarity rating above a first threshold T_{dupl} may be designated as duplicates and may be assigned to a corresponding cluster or group of duplicates 421a, and/or provided as an output to a user; each pair of documents which similarity rating is above a second threshold T_{ndupl}<T_{dupl} but is below the first threshold T_{dupl} may be designated as near-duplicates and maybe assigned to a corresponding cluster or group of near-duplicates, and/or provided as an output. By way of example, T_{ndupl} may be set to 85%, and T_{dupl} may be set to 95%, so that all pairs of documents with at least 95% of matching database fields in their stored signatures are declared to be duplicates. The process may output, or store, a list of duplicate documents and/or a list of near-duplicate documents.

As stated hereinabove, the document processing system of the present disclosure implementing one or more embodiments of the document clustering method that has been described hereinabove with reference to example embodiments, such as the DPS 110 of FIG. 1, may be embodied using a suitable computer system, such as but not exclusively one or more computer workstations, one or more desktop computers, a mobile computing device, or a combination thereof. Such a computer system may include one or more persistent memory devices implementing a data store, such as the signature store 122 of FIG. 4 that is configured for storing data using a plurality of fields, and one or more hardware processors configured to implement various functions and functional modules or logics described hereinabove. In one embodiment, these modules may include a search and indexing engine, such as S&IE 124, that is configured to perform fielded search and indexing on data stored in the data store, and a document processing logic, such as the document processing logic 111. The document processing logic may be configured to receive a plurality of electronic documents, and for each of the plurality of received electronic documents generate a signature based on a document textual content flow, the signature comprising a sequence of hashes, and store the signature in a sequence of fields of the data store, one hash per field, so that an order of hashes in the sequence of hashes uniquely corresponds to an order of fields in the sequence of fields storing the signature.

The one or more processors may further implement a clustering module or logic configured to: i) query the search and indexing engine with a signature query to identify, among all signatures stored in the data store, a first set of signatures wherein each signature comprises at least a predetermined number of fields which content matches corresponding hashes of a document signature specified in the signature query; and (ii) assign to a first cluster one or more of the electronic documents which signatures are in the first set.

In one embodiment, the search and indexing engine may be configured to perform fielded search and indexing on text data stored in the data store, and may further be configured to create an index of the text data stored in the data store, and to store said index in the one or more memory devices, wherein said index comprises location information for each of a plurality of terms stored in the data store. Here, location information may include, for example, IDs of all signatures where a specific signature term can be found.

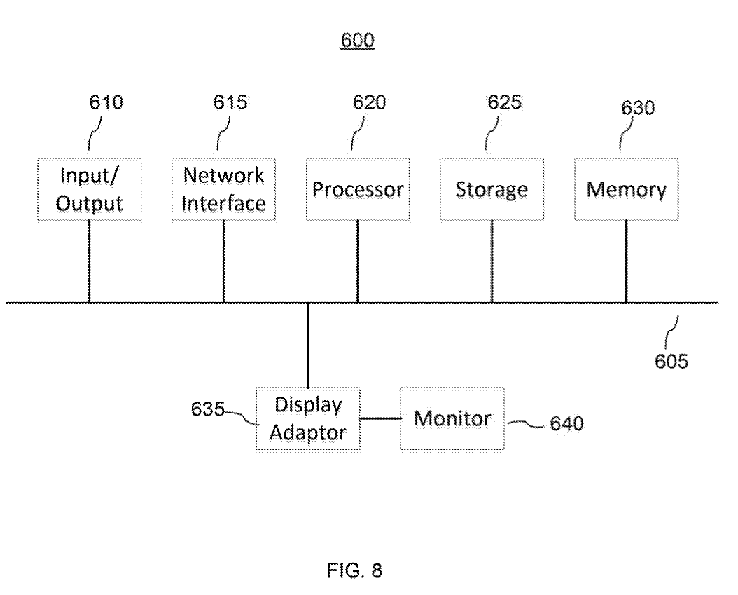

Referring to FIG. 8, there is illustrated an example computer system 600 that may be used to implement elements of the document clustering system and method embodiments of which have been describe hereinabove. The system 600 may include a processor 620, a memory 630, a storage device or devices 625, and input/output devices 610, a network interface device 615, a display adaptor 635 that may be connected to a display device such as computer monitor 640. Each of the components 610, 615, 620, 625, 630, and 635 are interconnected using a system bus 605. It will be appreciated that one or more of the devices illustrated in FIG. 6 may be omitted, with the processor 620, operating memory 630, and the storage 625 generally excepted to be present. The computer system 600 may be implemented, for example, using a desktop computer, a shelf computing unit, or a portable computing device, such as for example a laptop, a tablet computer, or a smartphone.

The processor 620 is capable of processing instructions for execution by various components of the system 600. Executed instructions can implement one or more components of the document processing system 110. The processor 620 may be a single core processor or a multi-core processor, and may also be embodied using more than one hardware processor chip. The network interface device 615 may be for example in the form of one or more network cards and is for communicating with other devices via a network, such as remotely located document servers 105 illustrated in FIG. 1, and/or one or more computing systems that may be implementing the database 120.

The processor 620 is capable of processing instructions stored in the memory 630 and/or on the storage device or devices 625, including instructions to display graphical information for a user interface on the monitor 640, and instructions to implement one or more of the components of the document processing system 110, and one or more of the steps and processes described hereinabove with reference to FIGS. 2, 4 and 5. By way of example, these instructions may include instructions to display a list of duplicate and/or near-duplicate documents as identified by the execution of document processing instructions described hereinabove with reference to a variant 400a of the clustering process 400 that identifies document duplicates and near-duplicates, as described hereinabove with reference to FIGS. 6 and 7. These instructions may also include instructions to display a list of document clusters, or a list of documents associated with any specific cluster, optionally with their similarity rating. These instructions may also include instructions to display clustering history of a selected document.

The memory 630 is a computer readable medium such as volatile or non-volatile memory that stores information within the system 100. The memory 630 may for example store data structures representing the full text searchable database 120, including the signature store 122 and the hash index 126, and the cluster database 118. The storage device 625 is capable of providing persistent storage for the system 600, and may be used for storing the signature store 122 and the cluster database 118. The storage device 625 may be a hard disk device, an optical disk device, a solid state disk memory, or other suitable persistent storage device. The input/output device 610 facilitates input/output operations for the system 600. It may include, for example, a keyboard and/or pointing device. The storage device or devices 625 may store computer program instructions which may be loaded into the system memory 630 and which execution by the processor 620 implements elements of the document processing system 110 and of the associated processes such as those illustrated in FIGS. 2, 4, and 5-7. Thus, applications for performing the herein-described method steps, such as document shingling, document signature generating and storing into the database, and clustering, in methods illustrated in FIGS. 2, and 5-7 are defined by the computer program instructions stored in the memory 630 and/or storage 625 and controlled by the processor 620 executing the computer program instructions.

In one embodiment, the database 120 for storing document signatures, and the associated S&IE 124 and index 126 may be implemented within the same computer system 600 using the memory 630, storage 625, and processor 620. In other embodiments, the database 120 may be implemented on another computer or computers that may be co-located with the computer system 600, or may be remote computers that communicate with the computer system 600 over a network. In one embodiment, the database 120 may be implemented in a distributed fashion using a plurality of network-connected computers.

The disclosed and other embodiments and the functional operations described in this specification can be implemented in digital electronic circuitry, or in computer software, firmware, or hardware, including the structures disclosed in this specification and their structural equivalents, or in combinations of one or more of them. The disclosed and other embodiments can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, or a combination of one or more them.

With reference to FIG. 10 by way of example, the document processing system and/or method of the present disclosure may be implemented using a non-transitory computer-readable medium 800 storing a processor-executable code 810 for clustering electronic documents based on similarity of textual content. The code comprises a set of instructions which, when executed by one or more processors, cause the one or more processors to perform a document clustering process or processes such as those described hereinabove. In one embodiment, the stored computer instructions may direct the one or more processors to execute a process that may include:

a) for each of a plurality of electronic documents stored by one or more document servers accessible by the one or more processors, a1) generate a signature for the document based on the document textual content flow, the signature comprising a sequence of hashes, and a2) store the signature in a database that is configured for storing data using a plurality of fields, and which comprises a search and indexing engine configured to perform fielded search on text data stored in the database;

b) query the search and indexing engine with a signature query to identify, among all signatures stored in the data store, a first set of signatures wherein each signature comprises at least a predetermined number of fields which content matches corresponding hashes of a document signature specified in the signature query; and

c) assign to a first cluster one or more of the electronic documents which signatures are in the first set.

In one embodiment, the stored computer instructions may direct the one or more processors to execute the following operations:

a) generating document signatures for a plurality of documents based on document textual content flow, each document signature comprising a list of hashes;

b) saving the document signatures in computer memory using a search and indexing engine comprising a document scoring function configured to return a document similarity rating in response to a signature query, and directing said engine to store each document signature in a separate document data structure containing a collection of fields, so that each hash of the document signatures is stored in a separate field of the document data structure;

c) querying the search and indexing engine with a fielded query, said fielded query listing the hashes of a signature of one of the plurality of documents, the search and indexing engine returning in response to the querying a list of stored signatures that include one or more fields which content match corresponding hashes listed in the fielded query;

d) directing the document scoring function of the search and indexing engine to compute the document similarity rating for each signature in the identified set, each similarity rating indicating the number of fields of a stored signature which content matches corresponding hashes listed in the query; and

e) assigning documents with signatures in the identified set and the similarity rating greater than a threshold value to a same document cluster.

In one embodiment, the instructions may include directing the search and indexing engine to generate, and store in memory prior to the querying, an inverse index of all signature terms, each signature term defined by a field and a hash stored in said field, the inverse index including a list of the stored signature terms, and, for each stored signature term, a list identifying all document signatures containing the respective signature term.

The non-transitory computer-readable medium 800 may be implemented using one or more persistent storage devices, and may also store the cluster database 118, the signature store 122, and the index 126 described hereinabove.

The terms ‘processor’ and “data processing apparatus” are used interchangeably and encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

A computer program, which may also be referred to as a program, software, software application, script, or code, can be written in any form of programming language, including compiled or interpreted languages, and it can be deployed in any form, including as a stand-alone program or as a module, component, subroutine, or other unit suitable for use in a computing environment. A computer program can be stored in a portion of a file that holds other programs or data, in a single file dedicated to the program in question, or in multiple coordinated files, for example files that store one or more modules, sub-programs, or portions of code. A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the disclosed embodiments can be implemented with a computer having a display device, such as but not exclusively an LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The disclosed embodiments can be implemented in a computing system which components can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes.

We claim:

1. A computer implemented method of clustering electronic documents based on similarity of textual content, the method comprising:
a) for each of a plurality of electronic documents,
a1) generating, by a computer, a signature for the electronic document based on a document textual content flow, the signature comprising a sequence of hashes;
a2) storing the signature in a database that is configured for storing data using a plurality of fields, and which comprises a search and indexing engine configured to perform fielded search on data stored in the database;
b) for a first document from the plurality of electronic documents, using the search and indexing engine to identify a first set of signatures stored in the database wherein each signature in the first set shares at least a predetermined number of hashes with the signature of the first document; and
c) assigning one or more of the electronic documents which signatures are in the first set to a first document cluster that is associated with the first document.

2. The method of claim 1, further comprising
d) for a second document from the plurality of electronic documents that has not yet been assigned to a document cluster, using the search and indexing engine to identify a second set of signatures stored in the database wherein each signature in the second set share at least a predetermined number of hashes with the signature of said second document;
e) assigning one or more of the electronic documents which signatures are in the second set to a second document cluster that is associated with the second document; and,
f) repeating steps d) and e) for each of the electronic documents that has not yet been assigned to a document cluster at any of the preceding steps.

3. The method of claim 2 wherein the search and indexing engine returns a similarity rating for each of the electronic documents which signatures are identified in steps b) and d), said similarity rating indicating the number of shared hashes.

4. The method of claim 3 wherein steps c) and e) include recording, in a document clustering history, the similarity rating and document cluster assignment for each electronic document being assigned to a cluster, and saving said document clustering history in a computer-readable memory.

5. The method of claim 4 including:
based at least in part on information stored in the document clustering history, determining, in step e), whether the second set includes a signature of a third electronic document that has been assigned to the first cluster with a first similarity rating,
if such signature is identified, comparing a second similarity rating assigned to the third electronic document in step d) to the first similarity rating;
if the second similarity rating associated with the second cluster is greater than the first similarity rating,
re-assigning the electronic document to the second cluster, and
recording the second similarity rating and the document cluster assignment for the third document in the document clustering history.

6. The method of claim 5 further comprising:
computing a cluster coupling coefficient for the first and second clusters based on the number of electronic documents in said clusters which similarity rating exceed pre-defined clustering thresholds for each of the first and second clusters, and
merging the first and second clusters into a single cluster if the cluster coupling coefficient exceeds a pre-defined cluster coupling threshold.

7. The method of claim 1, wherein
a2) comprises storing each hash from the sequence of hashes in a separate field of the database, so that the signature of each electronic document from the plurality of electronic documents is stored in a sequence of fields containing the respective sequence of hashes; and
b) comprises querying the search and indexing engine of the database for stored document signatures comprising at least a predetermined number of fields which content matches corresponding hashes in the sequence of hashes of the signature of the first document.

8. The method of claim 7, comprising the search and indexing engine performing field-based indexing of the signatures stored in the database prior to the querying.

9. The method of claim 8 wherein the field-based indexing comprises creating an inverted index identifying, for each of a plurality of hashes stored in the database, all stored document signatures that comprise said hash in corresponding fields, and wherein querying the search and indexing engine comprises querying the inverted index.

10. The method of claim 7 comprising using document text shingling and MinHashing techniques to generate the sequence of hashes.

11. The method of claim 7, wherein the storing comprises storing each of the hashes of the document signature in a separate field of the database that is configured to store and index text documents.

12. The method of claim 7 wherein
the search and indexing engine is configured to perform fielded search, indexing, and relevance scoring of documents, and
wherein the querying comprises querying the search and indexing engine with a query comprising a list of hash fields of the document signature joined with logical OR operators, each hash field comprising a field name paired with a corresponding hash from the sequence of hashes forming the signature of the first document.

13. The method of claim 12 wherein the search and indexing engine comprises one or more statistics functions configured to generate statistics for terms stored in the database and to return a document relevance score based on the statistics in response to a query,
the method comprising adapting the one or more statistics functions to return the document relevance score for each of the identified signatures in the form of a document similarity rating, said document similarity rating indicating the number of fields in a stored signature that match hash fields listed in the query.

14. The method of claim 12, wherein b) comprises:
responsive to the querying, receiving from the search and indexing engine a list of signatures, each signature identified in the list comprising at least one of the hash fields listed in the query, and a document similarity rating for each signature in the list indicating the number of hash fields matching hash fields listed in the query;
wherein c) comprises assigning to the first document cluster all documents which signatures are in the list of signatures returned by the search and indexing engine and have the document similarity rating exceeding a pre-defined threshold for the first document cluster.

15. The method of claim 1 wherein a1) comprises:
loading document data from the electronic document into computer-readable memory;
determining, by the computer, document textual content flow from the document data;
converting at least a portion of the document into a sequence of tokens based on the document textual content flow;
shingling the sequence of tokens to obtain a sequence of shingles;
applying one or more hash functions to the sequence of shingles to obtain the sequence of hashes comprising N hash values, where N is an integer greater than 1, wherein the N hash values are selected as the smallest hash values or the largest hash values from a plurality of hash values generated by the one or more hash functions from the sequence of shingles.

16. The method of claim 15, wherein the step of converting comprises arranging document text in sequential order in accordance with the document textual content flow.

17. A computer system for clustering electronic documents based on similarity of textual content, the computer system comprising:
one or more storage devices implementing a data store that is configured for storing data using a plurality of fields; and
one or more hardware processors configured to implement:
a search and indexing engine that is configured to perform fielded search and indexing on data stored in the data store;
a document processing logic configured to:
receive a plurality of electronic documents;
for each of the plurality of received electronic documents:
generate a signature based on a document textual content flow, the signature comprising a sequence of hashes; and
store the signature in a sequence of fields of the data store, one hash per field, so that an order of hashes in the sequence of hashes uniquely corresponds to an order of fields in the sequence of fields storing the signature;
a clustering logic configured to:
query the search and indexing engine with a signature query to identify, among all signatures stored in the data store, a first set of signatures wherein each signature comprises at least a predetermined number of fields which content matches corresponding hashes of a document signature specified in the signature query; and
assign to a first cluster one or more of the electronic documents which signatures are in the first set.

18. The computer system of claim 17, wherein the search and indexing engine is configured to create an index of hashes stored in the data store, and to store said index in the one or more storage devices, wherein said index comprises hash location information for each of a plurality of hashes stored in the data store, and is further configured to respond to a fielded search query using hash location information stored in the index.

19. A computer-implemented method of clustering documents based on similarity of textual content, the method comprising:
a) generating, by a document processing logic, document signatures for a plurality of documents based on document textual content flow, each document signature comprising a list of hashes;
b) saving the document signatures in computer memory using a search and indexing engine, so that each hash of the signatures is stored in a separate field of a data structure containing the signature, the search and indexing engine comprising one or more statistics functions capable of generating an index comprising frequency statistics for terms stored in said fields, and a document scoring function configured to return a document score in response to a search query using the frequency statistics stored in the index;
c) querying the search and indexing engine with a fielded query, said fielded query comprising a list of hashes of a signature of one of the plurality of documents, to identify a set of stored signatures that include one or more fields containing hashes that match corresponding hashes listed in the fielded query, and to compute a document similarity rating for each signature in the identified set using the document scoring function, each document similarity rating indicating the number of fields of a stored signature which content matches corresponding hashes listed in the query; and
d) assigning documents with signatures in the identified set and the similarity rating greater than a threshold value to a same document cluster.

20. The method of claim 14 wherein the first cluster is identified as:
a cluster of duplicate documents if the pre-defined threshold is a first threshold defined for duplicates identification, or
as a cluster of near-duplicate documents if the pre-defined threshold is a second threshold defined for near-duplicates identification, where the first threshold is greater than the second threshold, and the similarity rating for the document does not exceed the first threshold.
